(19) United States
(12) Patent Application Publication
(10) Pub. No.: US 2021/0027800 A1
(43) Pub. Date: Jan. 28, 2021

(54) METHOD FOR PROCESSING AUDIO, ELECTRONIC DEVICE AND STORAGE MEDIUM

(71) Applicant: Beijing Dajia Internet Information Technology Co., Ltd., Beijing (CN)

(72) Inventor: Chunxiang Wei, Beijing (CN)

(21) Appl. No.: 17/069,435

(22) Filed: Oct. 13, 2020

(30) Foreign Application Priority Data
Oct. 15, 2019 (CN) 201910979611.8

(51) Int. Cl. G10L 25/51; G10L 25/81

(52) U.S. Cl. CPC G10L 25/51; G10L 25/81

(57) ABSTRACT

Disclosed are a method for processing an audio, an electronic device and a storage medium. In the disclosure, audio information of a song selected by a song selection operation may be acquired as reference audio information when the song selection operation is received; vocal audio data is acquired and processed to obtain audio information of the vocal audio data as vocal audio information; and the vocal audio information is compared with the reference audio information so as to determine singing completeness of the vocal audio data as first singing completeness. The singing completeness of the vocal audio data is determined according to the vocal audio information and the reference audio information.

This application is based on and claims priority under 35 U.S.C 119 to Chinese Patent Application No. 201910979611.8, filed on Oct. 15, 2019, in the China National Intellectual Property Administration. The entire disclosure of the above application is incorporated herein by reference.

### FIELD

The present disclosure relates to the technical field of network videos and in particular to a method for processing audio, an electronic device and a storage medium.

### BACKGROUND

With the development of an internet technology, more and more abundant entertainment interaction forms have gradually appeared to meet demands of different users, watching live broadcast by virtue of a terminal device has become a more and more popular entertainment way, and live broadcast and karaoke combined live karaoke serving as a novel live broadcast interaction form has been favored by more and more users.

A live broadcasting room for live karaoke may be created by an anchor, a user may propose a singing request to the anchor after being accessed to the live broadcasting room, the user may display the sung song to other users by virtue of live broadcast after the anchor affirms the request, and meanwhile, the user may also select to listen to songs sung by other users.

### SUMMARY

According to a first aspect of the present disclosure, provided is a method for processing an audio, including:
obtaining first audio information by acquiring audio information of a song in response to that the song is selected, wherein the first audio information represents audio features for reflecting music characteristics of the song;
acquiring vocal audio data;
determining a singing completeness by comparing the second audio information with the first audio information, wherein the singing completeness represents a matching degree of the first song audio information and the second audio information.

Further, the method further includes:
displaying a song selection interface in response to that a singing request is received, wherein songs are displayed on the song selection interface; and
the obtaining the first audio information includes:
obtaining the first audio information in response to that the song is selected from the song selection interface.

Further, the acquiring the vocal audio data includes:
acquiring environmental audio data;
determining the vocal audio data by cancelling echo in the environmental audio data in response to that a device for implementing the method is detected to be in a loudspeaker mode, wherein the cancelling echo comprises cancelling environmental noise caused by live broadcast voices and comprised in the environmental audio data.

Further, the obtaining the first audio information includes:
obtaining a musical instrument digital interface file of the song, wherein the musical instrument digital interface file carries a first musical instrument digital interface data representing the first audio information;
the determining the vocal audio information includes:
converting the vocal audio data into a second musical instrument digital interface data;
the determining the singing completeness includes:
determining a matching degree of the second musical instrument digital interface data and the first musical instrument digital interface data as the singing completeness by comparing the second musical instrument digital interface data with the first musical instrument digital interface data.

Further, the acquiring the musical instrument digital interface file includes:
acquiring audio data of the song; and
converting the audio data into the musical instrument digital interface data, and generating the musical instrument digital interface file based on the musical instrument digital interface data.

Further, the method further includes:
displaying an effect animation corresponding to the singing completeness on a singing live broadcast interface based on a corresponding relationship between the singing completeness and the effect animation.

Further, the method further includes:
obtaining a lyric file of the song, wherein the lyric file comprises lyric information of the song, and the lyric information comprises a starting timestamp and an ending timestamp of a lyric;
determining a time period based on the starting timestamp and the ending timestamp;
the determining the singing completeness includes:
determining the singing completeness within the contrast time period by comparing the second audio information and the first audio information within the time period; and
the displaying the effect animation corresponding to the singing completeness on the singing live broadcast interface includes:
displaying the effect animation corresponding to the singing completeness on the singing live broadcast interface at a singing moment corresponding to the ending timestamp.

Further, the acquiring the vocal audio data includes:
acquiring the vocal audio data based on an acquisition period; or
acquiring the vocal audio data within the time period.

Further, the audio information includes at least one of following audio features:
audio pitch for reflecting pitch characteristics of the song;
audio rhythm for reflecting rhythm characteristics of the song; or
audio energy for reflecting energy characteristics of the song.

According to a second aspect of the present disclosure, provided is an electronic device including:
a processor; and
a memory for storing an instruction executable for the processor;
wherein the processor is configured to execute the instruction to implement followings:
obtaining first audio information by acquiring audio information of a song in response to that the song is selected, wherein the first audio information represents audio features for reflecting music characteristics of the song;
acquiring vocal audio data;
determining second audio information based on the vocal audio data;
determining a singing completeness by comparing the second audio information with the first audio information, wherein the singing completeness represents a matching degree of the first song audio information and the second audio information.

Further, the processor is configured to execute the instruction to implement followings:

displaying a song selection interface in response to that a singing request is received, wherein songs are displayed on the song selection interface;
the processor is configured to execute the instruction to obtain the first audio information by:
obtaining the first audio information in response to that the song is selected from the song selection interface.

Further, the processor is configured to execute the instruction to acquire the vocal audio data by:
acquiring environmental audio data; and
determining the vocal audio data by cancelling echo in the environmental audio data in response to that the apparatus is detected to be in a loudspeaker mode, wherein the cancelling echo comprises cancelling environmental noise caused by live broadcast voices and comprised in the environmental audio data.

Further, the processor is configured to execute the instruction to acquire the song audio information by:
obtaining a musical instrument digital interface file of the song, wherein the musical instrument digital interface file carries a first musical instrument digital interface data representing the first audio information;
the processor is configured to execute the instruction to determine the vocal audio information by:
converting the vocal audio data into a second musical instrument digital interface data;
the processor is configured to execute the instruction to determine the singing completeness by:
determining a matching degree of the second musical instrument digital interface data and the first musical instrument digital interface data as the singing completeness by comparing the second musical instrument digital interface data with the first musical instrument digital interface data.

Further, the processor is configured to execute the instruction to acquire the musical instrument digital interface file by:
acquiring audio data of the song; and
converting the audio data into the musical instrument digital interface data, and generating the musical instrument digital interface file based on the musical instrument digital interface data.

Further, the processor is further configured to execute the instruction to implement followings:
displaying an effect animation corresponding to the singing completeness on a singing live broadcast interface based on a corresponding relationship between the singing completeness and the effect animation.

Further, the processor is further configured to execute the instruction to implement followings:
obtaining a lyric file of the song, wherein the lyric file comprises lyric information of the song, and the lyric information comprises a starting timestamp and an ending timestamp of a lyric;
determining a time period based on the starting timestamp and the ending timestamp;
the processor is configured to execute the instruction to determine the singing completeness of the vocal audio data by:
determining the singing completeness within the contrast time period by comparing the second audio information and the first audio information within the time period; and
the processor is configured to execute the instruction to display the effect animation corresponding to the singing completeness on the singing live broadcast interface by:
displaying the effect animation corresponding to the singing completeness on the singing live broadcast interface at a singing moment corresponding to the ending timestamp.

Further, the processor is configured to execute the instruction to acquire the vocal audio data by:
acquiring the vocal audio data based on an acquisition period; or
acquiring the vocal audio data within the time period.

Further, the audio information includes at least one of following audio features:
audio pitch for reflecting pitch characteristics of the song;
audio rhythm for reflecting rhythm characteristics of the song; or
audio energy for reflecting energy characteristics of the song.

According to a third aspect of the present disclosure, provided is a storage medium; the storage medium includes an instruction, wherein the instruction is executed by a processor to implement any one of the above-mentioned method.

### BRIEF DESCRIPTION OF THE DRAWINGS

Accompanying drawings described herein are incorporated into the specification to construct a part of the specification, show embodiments conforming to the present disclosure and serve to explain the principle of the present disclosure together with the specification, rather than to construct improper limitations on the present disclosure.

FIG. 1 is a flow diagram of a method for processing audio shown according to an exemplary embodiment;

FIG. 2 is a flow diagram of a method for selection audio information shown according to an exemplary embodiment;

FIG. 3 is a schematic diagram of a song selection interface shown according to an exemplary embodiment;

FIG. 4 is a flow diagram of another method for processing audio shown according to an exemplary embodiment;

FIG. 5 is a block diagram of an apparatus for processing audio shown according to an exemplary embodiment; and

FIG. 6 is an electronic device shown according to an exemplary embodiment.

### DETAILED DESCRIPTION OF THE EMBODIMENTS

In order to make those ordinary skilled in the art better understand technical solutions of the present disclosure, the technical solutions in embodiments of the present disclosure will be described clearly and completely below in conjunction with accompanying drawings.

It should be noted that terms such as “first” and “second” in the specification and claims of the present disclosure and the above-mentioned accompanying drawings are used to distinguish similar objects, rather than to describe a specific order or precedence order. It should be understood that data used in such a way can be interchanged in an appropriate case so that the embodiments, described herein, of the present disclosure may be executed in an order other than those illustrated or described herein. Implementations described in the following exemplary embodiments do not represent all the implementations consistent with the present disclosure. Oppositely, they are only examples of apparatuses and methods described in detail in the appended claims and consistent with some aspects of the present disclosure.

FIG. 1 is a flow diagram of a method for processing audio shown according to an exemplary embodiment. As shown in FIG. 1, the method may be applied to a mobile terminal or desktop terminal device and includes the following steps.

S101: obtaining a song audio information as reference audio information in response to that the song is selected by a selection operation, wherein the song audio information represents audio features for reflecting music characteristics of the song.

In the step, the song selection operation may be a human-computer interaction action appointed in advance, wherein the human-computer interaction action appointed in advance may be a specified type of touch/click operation or a specified type of input operation of an external input device and may be different according to different types, operation habits and application demands of an application terminal.

For example, when the application terminal is a mobile intelligent terminal, the human-computer interaction action appointed in advance may be a double-click operation for the song; and when the application terminal is the desktop terminal device, the human-computer interaction action appointed in advance may be a click operation implemented by a user through a mouse.

It may be determined that the song selected by the song selection operation is a song that the user wants to sing Optionally, a song identifier of the song selected by the user may be determined, and the song audio information is acquired based on the song identifier.

The acquisition of the song audio information is determined according to an actual situation, when the selected song has been sung repeatedly, it is proven that the song audio information has been used before, i.e., it is possible that the song audio information is locally stored, at the moment, the song audio information may be directly acquired from a local storage space for storing the audio information; and on the other hand, when the song audio information does not exist locally, the song audio information may be acquired in a way of transmitting an audio information acquisition request to a server.

The above-mentioned audio information represents the audio features for reflecting music characteristics of the song, wherein the music characteristics of the song mainly include pitch, rhythm and loudness of the song, and the audio features include pitch characteristics, rhythm characteristics and loudness characteristics.

S102: acquiring vocal audio data and determining vocal audio information based on the vocal audio data.

In the step, the vocal audio data is audio data obtained by processing a sound made by a singer when the singer sings the song. It may be understood by those skilled in the art that the vocal audio data inevitably includes noise data including environmental noise data and accompaniment noise data when being acquired, wherein the accompaniment noise data is generated by a song accompaniment played when the singer sings, in order to ensure that the complete and accurate vocal audio data is acquired, initially acquired initial audio data is required to be denoised to remove the environmental noise data and the accompaniment noise data included in the initial audio data, and thus, the vocal audio data is obtained.

Optionally, the vocal audio data may be extracted to determine the pitch, rhythm or loudness of the sound made when the user sings the song, so that the vocal audio information is obtained.

S103: determining singing completeness of the vocal audio data as first singing completeness by comparing the vocal audio information with a reference audio information, wherein the singing completeness represents a matching degree of the song audio information and vocal audio information.

In the step, the vocal audio information of the vocal audio data may be compared with the reference audio information so as to determine the singing completeness of the vocal audio data. For example, pitch characteristics in the vocal audio data are compared with pitch characteristics included in the reference audio information, and when the pitch of the vocal audio data is 90 while the pitch of the reference audio information is 100 on the same sampling position, it may be determined that the singing completeness is 90%. Loudness comparison may be realized by comparing the change rate of the loudness or converting the loudness characteristics into energy characteristics.

In some embodiments, as shown in FIG. 1, provided by this application, the song audio information selected by the song selection operation is acquired as the reference audio information when the song selection operation is triggered, wherein the audio information represents the audio features for reflecting the music characteristics of the song; the vocal audio data is acquired and processed to obtain the vocal audio information of the vocal audio; the vocal audio information is compared with the reference audio information so as to determine the singing completeness of the vocal audio data as the first singing completeness, wherein the singing completeness represents the matching degree of the song audio information and the vocal audio information; and an effect animation corresponding to the first singing completeness is displayed on a singing live broadcast interface according to a pre-established corresponding relationship between the singing completeness and the effect animation. The singing completeness of the vocal audio data is determined according to the vocal audio information and the reference audio information, while the singing completeness may be used for accurately and objectively evaluating the singing level of the song.

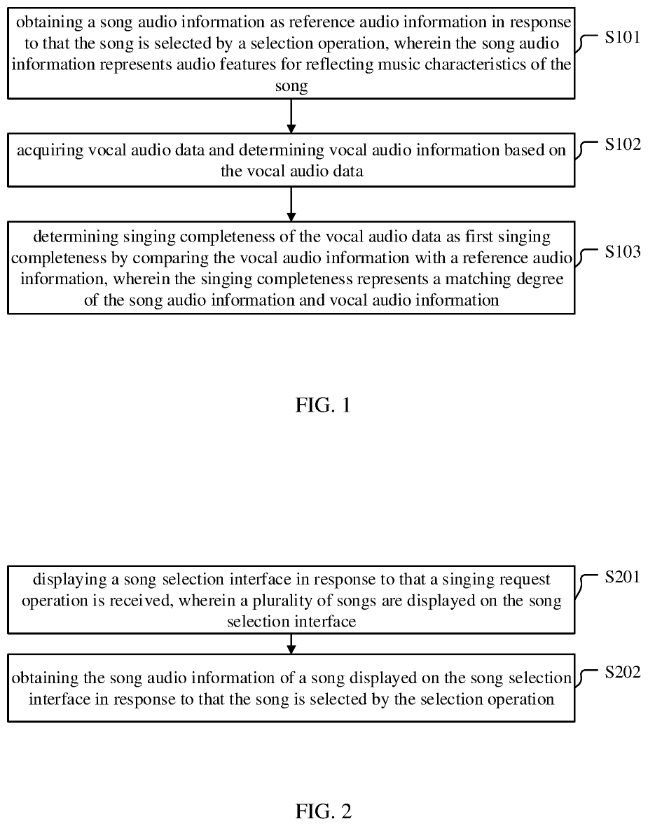

The above-mentioned S101 may be optionally implemented by adopting a method for selecting audio information as shown in FIG. 2, including the following steps.

S201: displaying a song selection interface in response to that a singing request operation is received, wherein a plurality of songs are displayed on the song selection interface.

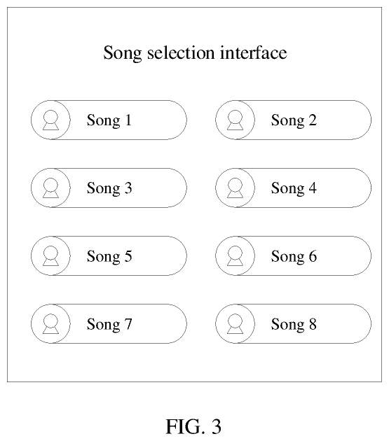

In the step, the song selection interface is used for displaying the songs, as shown in FIG. 3 which is a schematic diagram of one song selection interface, in FIG. 3, song 1 to song 8 are the songs to be selected by singing users.

A user may select to listen to the songs sung by other users or apply for singing after being accessed to a live broadcasting room for live karaoke. When wanting to sing in the live broadcasting room, the user may implement the singing request operation such as an operation of applying for getting a microphone. When receiving the singing request operation, the song selection interface is displayed for the user to select.

S202: obtaining the song audio information of a song displayed on the song selection interface in response to that the song is selected by the selection operation.

In the step, the user may select the song required to be sung by the user from the song selection interface, and the song selection operation and the acquisition of the song audio information selected by the song selection operation are similar to the implementation S101, the detailed descriptions thereof are omitted herein.

In some embodiments, as shown in FIG. 2, provided by this application, the song selection interface may be displayed when the singing request operation is received, wherein the songs are displayed on the song selection interface; and the song audio information selected by the song selection operation is acquired when the song selection operation for the songs displayed on the song selection interface is received. Due to the display of the song selection interface, the selection of the songs is more intuitive.

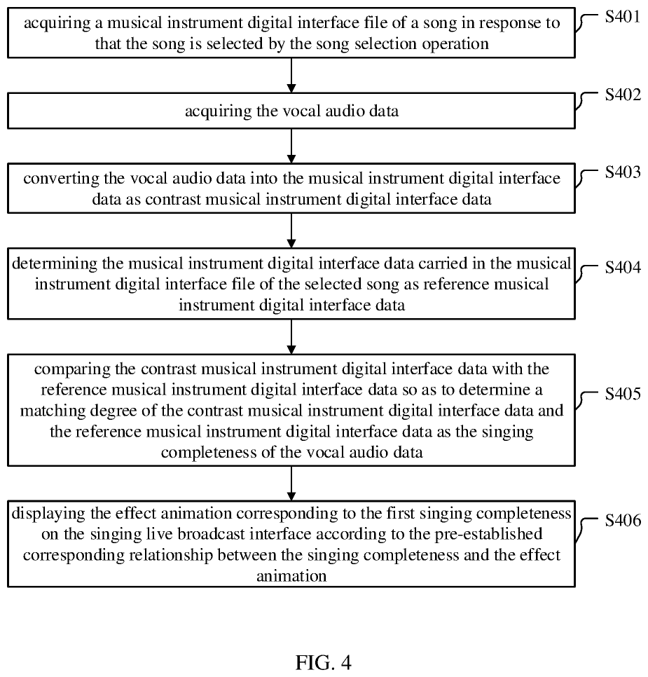

FIG. 4 is a flow diagram of another method for processing audio shown according to an exemplary embodiment. As shown in FIG. 4, the method includes the following steps.

S401: acquiring a musical instrument digital interface file of a song in response to that the song is selected by the song selection operation.

In the step, the musical instrument digital interface file carries musical instrument digital interface data representing the song audio information, and the song audio information represents audio features for reflecting music characteristics of the song.

The musical instrument digital interface file may be an MIDI (Musical Instrument Digital Interface) file, wherein MIDI data carried in the MIDI file of the song records information of the audio features such as the pitch, rhythm and loudness of the song, wherein the pitch of the song corresponds to audio pitch for reflecting pitch characteristics of the song, the rhythm of the song corresponds to audio rhythm for reflecting rhythm characteristics of the song, and the loudness of the song corresponds to audio energy for reflecting energy characteristics of the song.

Generally speaking, the above-mentioned pitch refers to a fundamental frequency, namely a frequency of a fundamental tone, in a song, and in a sound, the fundamental frequency refers to a frequency of a fundamental tone in a complex tone. In a plurality of tones forming one complex tone, the fundamental tone is lowest in frequency and highest in strength, and the size of fundamental frequency decides the pitch of a tone. The above-mentioned rhythm refers to a beat, while the beat means that a strong beat and a weak beat in music are periodically and regularly repeated. The above-mentioned loudness refers to energy of the sound, is also called volume and reflects sound intensity felt by ears of a person, and the loudness is a subjective sense of the person for the volume of the sound. The loudness is decided by a wave amplitude on a sound receiving position; for the same sound source, the farther the wave amplitude propagates, the smaller the loudness is; and when the propagation distance is fixed, the greater the vibration amplitude of the sound source is, the greater the loudness is. The loudness is closely related to the sound intensity, but the variation of the loudness with the sound intensity is approximately in a logarithmic relationship instead of a simple linear relationship. When the frequency and waveform of a sound wave of the sound are changed, the sense of the person for the loudness will be also changed.

In some embodiments, when the MIDI file does not exist in the song selected by the song selection operation, the MIDI file may be acquired in a way of acquiring initial audio data of the selected song and then converting the initial audio data into the MIDI file, and converting the audio data into the MIDI file is the prior art, the descriptions thereof are omitted herein.

In some embodiments, a lyric file of the song selected by the song selection operation may be further acquired while the musical instrument digital interface file of the song selected by the song selection operation is acquired, wherein the lyric file includes lyric information of the song selected by the song selection operation, and the lyric information includes a starting timestamp and an ending timestamp of a lyric; and a singing time period of the lyric may be determined as a contrast time period according to the starting timestamp and the ending timestamp of the lyric.

Exemplarily, the song includes three lyrics, the starting timestamp and the ending timestamp of lyric 1 are respectively 1s and 2s, the starting timestamp and the ending timestamp of lyric 2 are respectively 3s and 4s, and the starting timestamp and the ending timestamp of lyric 3 are respectively 6s and 7s, and thus, it may be determined that the contrast time period of lyric 1 is 1-2s, the contrast time period of lyric 2 is 3-4s, and the contrast time period of lyric 3 is 6-7s.

The contrast time period may be a singing time period of each sentence in the lyric file or a singing time period of each word in each lyric.

Exemplarily, the song includes one lyric “blue sky, white clouds”, and thus, the contrast time period may be a singing time period of one sentence in the lyric “blue sky, white clouds”, namely the contrast time period starts from the first word “blue” and ends with the last word “clouds”. The contrast time period may also be a singing time period for each single word in the lyric “blue sky, white clouds”, such as the word “blue” and the word “sky”.

S402: acquiring the vocal audio data.

In the step, the vocal audio data may be acquired in real time. Optionally, a singing starting button may be displayed after the song selection operation is triggered, and the vocal audio data may be started to be collected in real time when the singing starting button is triggered.

In some embodiments, when a device is in a loudspeaker mode, the device is required to play accompaniment music of a to-be-sung song, and there are voices of other users in the live broadcasting room, where the user is located, for live karaoke, so that various types of noise exist in a current singing environment, and in order to accurately acquire the vocal audio data, the noise existing in the singing environment has to be cancelled.

Optionally, the vocal audio data may be accurately acquired in following ways.

Acquiring environmental audio data, and performing echo cancellation on the environmental audio data in response to that the device is detected to be in the loudspeaker mode so as to obtain the vocal audio data, wherein the echo cancellation is used for cancelling environmental noise caused by live broadcast voices and included in the environmental audio data.

The environmental audio data is a set of various sounds in the singing environment and includes the accompaniment music, voices in the live broadcasting room and the like.

The loudspeaker mode is a voice broadcasting mode of an intelligent device in which the voice broadcasting mode may include a mode of performing broadcasting by virtue of a device such as an earphone and a mode of broadcasting voices by virtue of a loudspeaker of the intelligent device, and therefore, the loudspeaker mode may be the mode of broadcasting voices by virtue of the loudspeaker of the intelligent device.

The above-mentioned echo cancellation is a noise cancellation way for processing the received audio data according to the output audio data. The live broadcasting room for live karaoke mainly outputs two types of audios including accompaniment and live broadcasting voices to a broadcasting environment, echo cancellation on the acquired environmental audio data is performed based on audio data of the output accompaniment and live broadcasting voices, and thus, the accurate vocal audio data may be obtained.

In some embodiments, the vocal audio data may also be acquired according to a preset acquisition period, wherein the preset acquisition period may be determined according to a characteristic of the lyric or other demands, for example, every 10s may be used as one acquisition period.

In some embodiments, the vocal audio data may be further acquired within the contrast time period. Therefore, frequently processing audio data or processing a lot of audio data is avoided, and the audio data are only acquired and processed within the contrast time period.

S403: converting the vocal audio data into the musical instrument digital interface data as contrast musical instrument digital interface data.

In the step, the acquired vocal audio data may be converted into the MIDI data by extracting parameters of the pitch characteristics of the vocal audio data, specifically referring to the prior art, the descriptions thereof are omitted herein.

S404: determining the musical instrument digital interface data carried in the musical instrument digital interface file of the selected song as reference musical instrument digital interface data.

In the step, the MIDI file of the selected song is read to acquire the reference MIDI data.

S405: comparing the contrast musical instrument digital interface data with the reference musical instrument digital interface data so as to determine a matching degree of the contrast musical instrument digital interface data and the reference musical instrument digital interface data as the singing completeness of the vocal audio data.

In the step, the contrast musical instrument digital interface data may be compared with the reference musical instrument digital interface data. Optionally, the contrast musical instrument digital interface data and the reference musical instrument digital interface data at the same singing moment may be compared, exemplarily, the singing duration of the song is 60s, then, the contrast musical instrument digital interface data and the reference musical instrument digital interface data at the same singing moment are compared, for example, the contrast musical instrument digital interface data and the reference musical instrument digital interface data at the singing moment 1s are compared, the contrast musical instrument digital interface data and the reference musical instrument digital interface data at the singing moment 2s are compared, and the rest may be done in the same manner.

Further, as known as those skilled in the art, in one song, a singer only sings parts corresponding to the lyric in the song, but parts except the lyric are not required to be sung by the singer, and therefore, in order to increase the contrast efficiency and improve the contract accuracy, the contrast musical instrument digital interface data and the reference musical instrument digital interface data which are only within the contrast time period may be compared, namely the vocal audio information and the reference audio information which are within the contrast time period are compared so as to determine the singing completeness of the vocal audio data within the contrast time period.

Exemplarily, if the contrast time period is 1s-10s, it is proven that lyrics are included within the time period 1s-10s, and therefore, the contrast musical instrument digital interface data and the reference musical instrument digital interface data within 1s-10s may be compared.

The specific comparison process is similar to S103, the descriptions thereof are omitted herein.

The vocal audio information and the reference audio information which are within the contrast time period are compared so as to determine the singing completeness of the vocal audio data within the contrast time period.

S406: displaying the effect animation corresponding to the first singing completeness on the singing live broadcast interface according to the pre-established corresponding relationship between the singing completeness and the effect animation.

In the step, the singing completeness may correspond to different effect animations, for example, the effect animation may be a figure corresponding to the singing completeness, for example, if the singing completeness is 80%, “80” is displayed, or the effect animation may be a figure obtained by further processing, and thus, the singing completeness of the vocal audio data may be intuitively determined.

Alternatively, different singing completeness may be divided into a plurality of levels, and each level corresponds to one effect animation, for example, the singing completeness may be divided into four levels including bad, ordinary, better and excellent, the singing completeness lower than 60% may be defined to be bad, the singing completeness equal to 60%-80% is defined to be ordinary, the singing completeness equal to 80%-90% is defined to be better, the singing completeness greater than 90% is defined to be excellent, and all the levels respectively correspond to different effect animations.

In some embodiments, the effect animation corresponding to the first singing completeness may also be displayed on the singing live broadcast interface at a singing moment corresponding to the ending timestamp of the lyric.

For example, when the contrast time period is the singing time period of each lyric in the lyric file, a corresponding effect animation is displayed at the ending timestamp of the last character in each lyric.

For example, for the lyric “blue sky, white clouds”, the effect animation corresponding to the first singing completeness is displayed at the singing moment corresponding to the ending timestamp of the lyric.

When the contrast time period is the singing time period of each character in each lyric of the lyric file, a corresponding effect animation is displayed at the ending timestamp of each character in each lyric.

For example, for the lyric “blue sky, white clouds”, effect animations may be displayed on positions corresponding to the ending timestamps of words of “blue” and “white”.

In some embodiments, the above-mentioned effect animation may be a scoring animation.

In some embodiments, the overall singing completeness of the song may be obtained by integrating the singing completeness of each word or each sentence after singing is ended, and thus, the effect animation may be further displayed according to the overall singing completeness or the overall singing completeness may be used to meet other demands.

In some embodiments, as shown in FIG. 4, provided by this application, the musical instrument digital interface file of the song is acquired in response to that the song is selected by the song selection operation; the vocal audio data is acquired; the vocal audio data is converted into the musical instrument digital interface data as the contrast musical instrument digital interface data; the musical instrument digital interface data carried in the musical instrument digital interface file of the selected song is determined as the reference musical instrument digital interface data; the contrast musical instrument digital interface data is compared with the reference musical instrument digital interface data so as to determine the matching degree of the contrast musical instrument digital interface data and the reference musical instrument digital interface data as the singing completeness of the vocal audio data; and the effect animation corresponding to the first singing completeness is displayed on the singing live broadcast interface according to the pre-established corresponding relationship between the singing completeness and the effect animation. Since the audio features of the song may be rapidly and accurately determined by virtue of the MIDI file, the singing completeness of the vocal audio data may be rapidly determined in a way of comparing the MIDI data, and further, the effect animation corresponding to the singing completeness may be usually displayed on the singing live broadcast interface when a singer sings a song by virtue of live karaoke, thereby enriching the display effect of the singing live broadcast interface and improving the user viscosity.

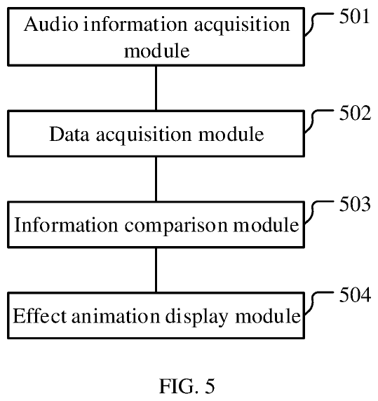

FIG. 5 is a block diagram of an apparatus for processing audio shown according to an exemplary embodiment. Referring to FIG. 5, the apparatus includes an audio information acquisition module 501, a data acquisition module 502 and an information comparison module 503.

The audio information acquisition module 501 is configured to acquire audio information of a song as reference audio information in response to that the song is selected by a selection operation, wherein the audio information represents audio features for reflecting music characteristics of the song;

The data acquisition module 502 is configured to acquire and process vocal audio data to obtain vocal audio information of the vocal audio data.

The information comparison module 503 is configured to compare the vocal audio information with the reference audio information so as to determine singing completeness of the vocal audio data as first singing completeness, wherein the singing completeness represents a matching degree of the song audio information and vocal audio information.

Further, the audio information acquisition module 501 is configured to display a song selection interface in response to that a singing request operation is received and acquire the song audio information in response to that the song is selected by the song selection operation, wherein the songs are displayed on the song selection interface.

Further, the data acquisition module 502 is configured to acquire environmental audio data and perform echo cancellation on the environmental audio data in response to that a device is detected to be in a loudspeaker mode so as to obtain the vocal audio data, wherein the echo cancellation is used for cancelling environmental noise caused by live broadcast voices and included in the environmental audio data.

Further, the audio information acquisition module 501 is configured to acquire a musical instrument digital interface file of the song, wherein the musical instrument digital interface file carries musical instrument digital interface data representing the audio information of the selected song.

The data acquisition module 502 is configured to convert the vocal audio data into the musical instrument digital interface data as contrast musical instrument digital interface data.

The information comparison module 503 is configured to determine the musical instrument digital interface data carried in the musical instrument digital interface file as reference musical instrument digital interface data and compare the contrast musical instrument digital interface data with the reference musical instrument digital interface data so as to determine a matching degree of the contrast musical instrument digital interface data and the reference musical instrument digital interface data as the singing completeness of the vocal audio data.

Further, the audio information acquisition module 501 is configured to acquire the song audio data as reference audio data and convert the reference audio data into the musical instrument digital interface data so as to generate the musical instrument digital interface file.

Further, the apparatus further includes an effect animation display module 504, configured to display an effect animation corresponding to the first singing completeness on a singing live broadcast interface according to a pre-established corresponding relationship between the singing completeness and the effect animation.

Further, the audio information acquisition module 501 is configured to acquire a lyric file of the song and determine a singing time period of a lyric as a contrast time period according to a starting timestamp and an ending timestamp of the lyric, wherein the lyric file includes lyric information of the song, and the lyric information includes the starting timestamp and the ending timestamp of the lyric.

The information comparison module 503 is configured to compare the vocal audio information and the reference audio information within the contrast time period so as to determine the singing completeness of the vocal audio data within the contrast time period.

Further, the data acquisition module 502 is configured to acquire the vocal audio data according to a preset acquisition period or acquire the vocal audio data within the contrast time period.

The effect animation display module 504 is configured to display the effect animation corresponding to the first singing completeness on the singing live broadcast interface at a singing moment corresponding to the ending timestamp.

Further, the audio information at least represents one of the following audio features:
audio pitch for reflecting pitch characteristics of the song;
audio rhythm for reflecting rhythm characteristics of the song; or
audio energy for reflecting energy characteristics of the song, which means that the audio information is only the audio pitch, only the audio rhythm, only the audio energy, both the audio pitch and the audio rhythm, both the audio pitch and the audio energy, both the rhythm and the audio energy, all of the audio pitch, the audio rhythm and the audio energy, or variations thereof.

With regard to the apparatuses in the above-mentioned embodiments, a specific way that each module executes the operation has been described in detail in the embodiments related to the method, the descriptions thereof are omitted herein.

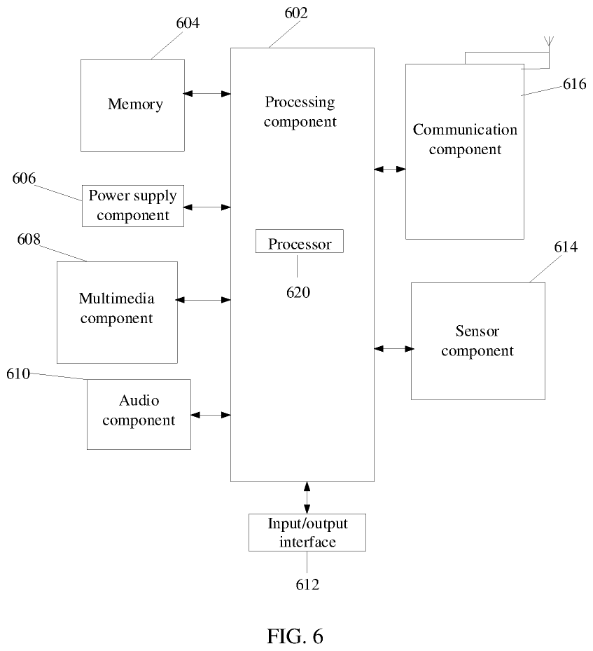

FIG. 6 is a block diagram of an electronic device 600 for processing audio, shown according to an exemplary embodiment. For example, the electronic device may be a mobile phone, a computer, a digital broadcasting terminal, a message transceiving device, a game console, a flat panel device, a medical device, a fitness device, a personal digital assistant and the like.

Referring to FIG. 6, the electronic device may include one or more components as follows: a processing component 602, a memory 604, a power supply component 606, a multimedia component 608, an audio component 610, an input/output (I/O) interface 612, a sensor component 614 and a communication component 616.

The processing component 602 generally controls the overall operation of the electronic device, such as operations associated with display, telephone calling, data communication, camera operation and recording operation. The processing component 602 may include one or more processors 620 to execute an instruction so as to complete all or parts of steps of the above-mentioned method. In addition, the processing component 602 may include one or more modules facilitating the interaction between the processing component 602 and each of other components. For example, the processing component 602 may include a multimedia module so as to facilitate the interaction between the multimedia component 608 and the processing component 602.

The memory 604 is configured to store various types of data so as to support the operations on the electronic device. An example of the data includes an instruction for operating any programs or methods on the electronic device, contact data, telephone directory data, messages, pictures, videos and the like. The memory 604 may be realized by any types of volatile or non-volatile storage devices or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disc.

The power supply component 606 provides power for various components of the electronic device. The power supply component 606 may include a power supply management system, one or more power supplies and other components associated with the generation, management and power distribution of the electronic device.

The multimedia component 608 includes a screen located between the electronic device and a user and provided with an output interface. In some embodiments, the screen may include a liquid crystal display (LCD) and a touch panel (TP). If the screen includes the TP, the screen may be realized as a touch screen so as to receive an input signal from the user. The TP includes one or more touch sensors so as to sense touch, slip and gestures on the TP. The touch sensor not only may sense the boundary of a touch or slip action, but also may detect duration time and pressure related to the touch or slip operation. In some embodiments, the multimedia component 608 includes a front camera and/or a rear camera. When the device 600 is in an operating mode such as a shooting mode or a video mode, the front camera and/or a rear camera may receive external multimedia data. Each of the front camera and the rear camera may be a fixed optical lens system or may have focal length and optical zooming capability.

The audio component 610 is configured to output and/or input an audio signal. For example, the audio component 610 includes a microphone (MIC), when the electronic device is in the operating mode such as a calling mode, a recording mode and a voice recognition mode, the MIC is configured to receive an external audio signal. The received audio signal may be further stored in the memory 604 and may be transmitted by the communication component 616. In some embodiments, the audio component 610 further includes a loudspeaker for outputting an audio signal.

The I/O interface 612 is provided between the processing component 602 and a peripheral interface module, the above-mentioned peripheral interface module may be a keyboard, a click wheel, buttons and the like. These buttons may include, but are not limited to a homepage button, a volume button, a start button and a lock button.

The sensor component 614 includes one or more sensors for providing state evaluation on various aspects for the electronic device. For example, the sensor component 614 may detect a starting/stopping state of the device 600 and relative locations of the components, for example, the component is used as a display and a keypad of the electronic device, and the sensor component 614 may also detect the position change of the electronic device or one component of the electronic device, the existence or inexistence of contact between a user and the electronic device, the orientation or acceleration/deceleration of the electronic device and the temperature variation of the electronic device. The sensor component 614 may include a proximity sensor configured to detect the existence of a nearby object when no any physical contacts exist. The sensor component 614 may further include an optical sensor such as a CMOS or CCD image sensor used in imaging applications. In some embodiments, the sensor component 614 may further include an acceleration sensor, a gyroscope sensor, a magnetic sensor, a pressure sensor or a temperature sensor.

The communication component 616 is configured to facilitate the communication between the electronic device and any one of other devices in a wired or wireless way. The electronic device may be accessed to a wireless network based on a communication standard, such as a WiFi, an operator network (such as 2G, 3G, 4G or 5G) or a combination thereof. In an exemplary embodiment, the communication component 616 receives a broadcast signal or broadcasts related information from an external broadcast management system through a broadcast channel. In one exemplary embodiment, the communication component 616 further includes a near-field communication (NFC) module so as to facilitate short-range communication. For example, the NFC module may be realized based on a radio frequency identification (RFID) technology, an infrared data association (IrDA) technology, an ultrawide band (UWB) technology, a Bluetooth (BT) technology and other technologies.

In an exemplary embodiment, the electronic device may be realized by one or more application specific integrated circuits (ASICs), a digital signal processor (DSP), a digital signal processing device (DSPD), a programmable logic device (PLD), a field-programmable gate array (FPGA), a controller, a microcontroller, a microprocessor or other electronic elements and is used for executing the above-mentioned method.

In an exemplary embodiment, further provided is a storage medium including an instruction, such as a memory 604 including an instruction, and the above-mentioned instruction may be executed by the processor 620 of the electronic device so as to complete the above-mentioned method. Optionally, the storage medium may be a non-transient computer readable storage medium, for example, the non-transient computer readable storage medium may be an ROM, a random access memory (RAM), a CD-ROM, a magnetic tape, a floppy disk, an optical data storage device and the like.

Other implementation solutions will be readily envisioned by those skilled in the art after considering the specification and putting the present disclosure disclosed herein into practice. This application aims at covering any variations, purposes or adaptive changes of the present disclosure, and these variations, purposes or adaptive changes conform to a general principle of the present disclosure and include common general knowledge or conventional technical means in the undisclosed technical field of the present disclosure. The specification and the embodiments are merely regarded to be exemplary, and the true scope and spirit of the present disclosure are appointed by the following claims.

It should be understood that the present disclosure is not limited to precise structures which have been described above and shown in the accompanying drawings, and various modifications and alterations may be made without departing from the scope thereof. The scope of the present disclosure is merely limited by the appended claims.

What is claimed is:

1. A method for processing an audio, comprising:
obtaining first audio information by acquiring audio information of a song in response to that the song is selected, wherein the first audio information represents audio features for reflecting music characteristics of the song;
acquiring vocal audio data;
determining second audio information based on the vocal audio data;
determining a singing completeness by comparing the second audio information with the first audio information, wherein the singing completeness represents a matching degree of the first song audio information and the second audio information.

2. The method according to claim 1, further comprises:
displaying a song selection interface in response to that a singing request is received, wherein songs are displayed on the song selection interface; and
said obtaining the first audio information comprises:
obtaining the first audio information in response to that the song is selected from the song selection interface.

3. The method according to claim 1, wherein said acquiring the vocal audio data comprises:
acquiring environmental audio data; and
determining the vocal audio data by cancelling echo in the environmental audio data in response to that a device for implementing the method is detected to be in a loudspeaker mode, wherein the cancelling echo comprises cancelling environmental noise caused by live broadcast voices and comprised in the environmental audio data.

4. The method according to claim 1, wherein said obtaining the first audio information comprises:
obtaining a musical instrument digital interface file of the song, wherein the musical instrument digital interface file carries a first musical instrument digital interface data representing the first audio information;
said determining the vocal audio information comprises:
converting the vocal audio data into a second musical instrument digital interface data;
said determining the singing completeness comprises:
determining a matching degree of the second musical instrument digital interface data and the first musical instrument digital interface data as the singing completeness by comparing the second musical instrument digital interface data with the first musical instrument digital interface data.

5. The method according to claim 4, wherein said acquiring the musical instrument digital interface file comprises:
acquiring audio data of the song; and
converting the audio data into the musical instrument digital interface data, and generating the musical instrument digital interface file based on the musical instrument digital interface data.

6. The method according to claim 1, further comprising:
displaying an effect animation corresponding to the singing completeness on a singing live broadcast interface based on a corresponding relationship between the singing completeness and the effect animation.

7. The method according to claim 6, further comprises:
obtaining a lyric file of the song, wherein the lyric file comprises lyric information of the song, and the lyric information comprises a starting timestamp and an ending timestamp of a lyric;
determining a time period based on the starting timestamp and the ending timestamp;
said determining the singing completeness comprises:
determining the singing completeness within the contrast time period by comparing the second audio information and the first audio information within the time period; and
said displaying the effect animation corresponding to the singing completeness on the singing live broadcast interface comprises:
displaying the effect animation corresponding to the singing completeness on the singing live broadcast interface at a singing moment corresponding to the ending timestamp.

8. The method according to claim 7, wherein said acquiring the vocal audio data comprises:
acquiring the vocal audio data based on an acquisition period; or
acquiring the vocal audio data within the time period.

9. The method according to claim 1, wherein the audio information comprises at least one of following audio features:
audio pitch for reflecting pitch characteristics of the song;
audio rhythm for reflecting rhythm characteristics of the song; or
audio energy for reflecting energy characteristics of the song.

10. An electronic device for processing audio, comprising:
a processor; and
a memory for storing an instruction executable for the processor;
wherein the processor is configured to execute the instruction to implement followings:
obtaining first audio information by acquiring audio information of a song in response to that the song is selected, wherein the first audio information represents audio features for reflecting music characteristics of the song;
acquiring vocal audio data;
determining second audio information based on the vocal audio data;
determining a singing completeness by comparing the second audio information with the first audio information, wherein the singing completeness represents a matching degree of the first song audio information and the second audio information.

11. The apparatus according to claim 10, wherein the processor is configured to execute the instruction to implement followings:
displaying a song selection interface in response to that a singing request is received, wherein songs are displayed on the song selection interface;
the processor is configured to execute the instruction to obtain the first audio information by:
obtaining the first audio information in response to that the song is selected from the song selection interface.

12. The apparatus according to claim 10, wherein the processor is configured to execute the instruction to acquire the vocal audio data by:
acquiring environmental audio data; and
determining the vocal audio data by cancelling echo in the environmental audio data in response to that the apparatus is detected to be in a loudspeaker mode, wherein the cancelling echo comprises cancelling environmental noise caused by live broadcast voices and comprised in the environmental audio data.

13. The apparatus according to claim 10, wherein the processor is configured to execute the instruction to acquire the first audio information by:
obtaining a musical instrument digital interface file of the song, wherein the musical instrument digital interface file carries a first musical instrument digital interface data representing the first audio information;
the processor is configured to execute the instruction to determine the vocal audio information by:
converting the vocal audio data into a second musical instrument digital interface data;
the processor is configured to execute the instruction to determine the singing completeness by:
determining a matching degree of the second musical instrument digital interface data and the first musical instrument digital interface data as the singing completeness by comparing the second musical instrument digital interface data with the first musical instrument digital interface data.

14. The apparatus according to claim 13, wherein the processor is configured to execute the instruction to acquire the musical instrument digital interface file by:
acquiring audio data of the song; and
converting the audio data into the musical instrument digital interface data, and generating the musical instrument digital interface file based on the musical instrument digital interface data.

15. The apparatus according to claim 10, wherein the processor is further configured to execute the instruction to implement followings:
displaying an effect animation corresponding to the singing completeness on a singing live broadcast interface based on a corresponding relationship between the singing completeness and the effect animation.

16. The apparatus according to claim 15, wherein the processor is further configured to execute the instruction to implement followings:
obtaining a lyric file of the song, wherein the lyric file comprises lyric information of the song, and the lyric information comprises a starting timestamp and an ending timestamp of a lyric;
determining a time period based on the starting timestamp and the ending timestamp;
the processor is configured to execute the instruction to determine the singing completeness by:
determining the singing completeness within the contrast time period by comparing the second audio information and the first audio information within the time period; and
the processor is configured to execute the instruction to display the effect animation corresponding to the singing completeness on the singing live broadcast interface by:
displaying the effect animation corresponding to the singing completeness on the singing live broadcast interface at a singing moment corresponding to the ending timestamp.

17. The apparatus according to claim 16, wherein the processor is configured to execute the instruction to acquire the vocal audio data by:
acquiring the vocal audio data based on an acquisition period; or
acquiring the vocal audio data within the time period.

18. The apparatus according to claim 10, wherein the audio information comprises at least one of following audio features:
audio pitch for reflecting pitch characteristics of the song;
audio rhythm for reflecting rhythm characteristics of the song; or
audio energy for reflecting energy characteristics of the song.

19. A storage medium, comprising an instruction, wherein the instruction is executed by a processor to implement the method according to claim 1.
